(19) United States
(12) Patent Application Publication
(10) Pub. No.: US 2017/0351608 A1
(43) Pub. Date: Dec. 7, 2017

(54) HOST DEVICE

(71) Applicant: TOSHIBA MEMORY CORPORATION, Minato-ku (JP)

(72) Inventor: Kenji SHIRAKAWA, Sagamihara (JP)

(73) Assignee: TOSHIBA MEMORY CORPORATION, Minato-ku (JP)

(21) Appl. No.: 15/450,175

(22) Filed: Mar. 6, 2017

Related U.S. Application Data
(60) Provisional application No. 62/346,621, filed on Jun. 7, 2016.

(51) Int. Cl. G06F 12/02; G06F 3/06

(52) U.S. Cl. CPC G06F 12/0269; G06F 3/0652; G06F 3/0683; G06F 3/0608; G06F 3/0641; G06F 2212/1044

(57) ABSTRACT

According to one embodiment, a host device is provided. The host device includes a processor that stores a log of a file in plurality of storages using a log -structured file system. The processor selects in which of the plural storages to store a log which is determined to be live in garbage collection which is a process of determining whether the log is live.

### CROSS-REFERENCE TO RELATED APPLICATIONS

This application is based upon and claims the benefit of priority from U.S. Provisional Application No. 62/346,621, filed on Jun. 7, 2016; the entire contents of which are incorporated herein by reference.

### FIELD

Embodiments described herein relate generally to a host device.

### BACKGROUND

A process which is called data migration (block migration) is known as one process for storing data in a storage device. The data migration is a process of transmitting data between different types of storages, formats, or computers. For example, a storage system in which plural devices (such as SSDs, HDDs, or archives) having different characteristics are combined is constituted by the data migration. In the data migration, in what “tier” data should be stored is determined depending on attributes or usages of data. When the data migration is performed, it is preferable to easily perform the data migration while suppressing a reading/writing load.

### BRIEF DESCRIPTION OF THE DRAWINGS

FIG. 1 is a block diagram illustrating a hardware configuration of a host device according to a first embodiment;

FIG. 2A is a diagram illustrating a configuration of a block pointer for referring to a data block;

FIG. 2B is a diagram illustrating a configuration of a block pointer for referring to a data block via a de-duplication hash table;

FIG. 3 is a diagram illustrating a functional configuration of the host device according to the first embodiment;

FIG. 4 is a block diagram illustrating a configuration of an LFS according to the first embodiment;

FIG. 5 is a diagram illustrating a configuration of a storage;

FIG. 6 is a diagram illustrating a relationship between an FS and various tables;

FIG. 7 is a flowchart illustrating a process flow of a data migration process according to the first embodiment;

FIG. 8 is a diagram illustrating a live determining process according to the first embodiment;

FIG. 9 is a block diagram illustrating a configuration of a LFS according to a second embodiment;

FIG. 10A is a diagram illustrating a configuration of a segment entry when a representative block is selected by de-duplication;

FIG. 10B is a diagram illustrating a configuration of a segment entry when a file refers to a representative block after de-duplication has been performed;

FIG. 11 is a flowchart illustrating a process flow of a first de-duplication process according to the second embodiment;

FIG. 12 is a diagram illustrating a process of reference to data from a file; and

FIG. 13 is a diagram illustrating a process of reference to a file data.

### DETAILED DESCRIPTION

According to one embodiment, there is provided a host device. The host device includes a processor configured to store a log of a file in plurality of storages using a log-structured file system. The processor selects in which of the plural storages to store a log which is determined to be live in garbage collection which is a process of determining whether the log is live.

Hereinafter, a host device according to embodiments will be described in detail with reference to the accompanying drawings. The present invention is not limited to the embodiments.

### First Embodiment

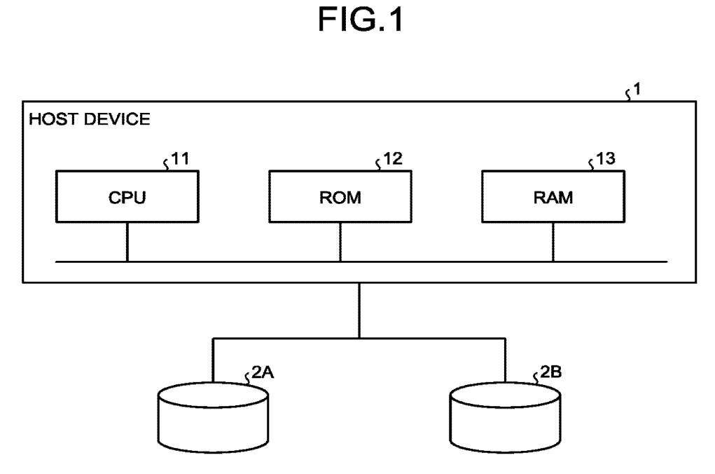

FIG. 1 is a block diagram illustrating a hardware configuration of a host device according to a first embodiment. The host device 1 is connected to storages 2A and 2B. The host device 1 stores data in the storages 2A and 2B. For example, the host device 1 may be an information processing device such as a personal computer, a portable phone, an imaging device, or a mobile terminal such as a tablet computer or a smartphone. The host device may be a game machine or an onboard terminal such as a car navigation system.

The storages 2A and 2B operates as external storage devices of the host device 1. The storages 2A and 2B are storage mediums in which data is retained when power is not supplied. Examples of the storages 2A and 2B include a magnetic disk (such as a hard disk drive), an optical disc (such as CD/DVD/Blu-ray Disc), a flash memory storage device (such as USB memory/memory card/SSD), and a magnetic tape. The storages 2A and 2B may be storage devices of different types. Hereinafter, at is assumed that the storages 2A and 2B are disk devices.

The storage 2A and the storage 2B are different from each other, for example, in characteristics. In this embodiment, it is assumed that the storage 2A has a read or write processing speed faster than that of the storage 2B.

The host device 1 includes a central processing unit (CPU) 11, a read only memory (ROM) 12, a random access memory (RAM) 13. In the host device 1, the CPU 11, the ROM 12, and the RAM 13 are connected via a bus line.

The CPU 11 controls the host device 1 by executing an operating system (OS) or a user program. The CPU 11 controls reading, writing, and erasing of data with respect to the storages 2A and 2B, a log-structured file system (LFS), data migration (tiering), data management, and the like using one or more computer programs.

The computer program which is used by the CPU 11 is recorded on a non-transitory computer-readable recording medium including plural commands which can be executed by a computer and can be distributed as a computer program product. The computer program causes a computer to execute plural commands to control the storages 2A and 2B.

The computer program which is used by the CPU 11 is stored in the ROM 12 and is loaded into the RAM 13 via the bus line. The CPU 11 executes the computer program loaded into the RAM 13. In other words, the functions of the computer program are realised by causing the CPU 11 to execute the computer program. Specifically, in the host device 1, in accordance with the instruction input by the user, the CPU 11 reads the computer program from the ROM 12, loads the read computer program in a program storage area in the RAM 13, and performs various processes. The CPU 11 temporarily stores a variety of data generated in performing various processes in a data storage area formed in the RAM 13. As the RAM 13, a dynamic random access memory (DRAM) a static random access memory (SRAM), a ferroelectric random access memory (FeRAM), a magnetoresistive random access memory (MRAM), a phase change random access memory (PRAM), or the like can be employed.

The computer program which is executed in the host device 1 includes one or more control program of controlling the LFS, the data migration, the data management, and the like. The control program is configured as a module including an edit log generating unit 21, a segment managing unit 22, an output segment selecting unit 23, a segment writing unit 24, a live determining unit 25, a segment reading unit 26, and the like, which are loaded onto the RAM 13 which is a main storage device and are generated on the RAM 13.

The host device 1 stores data such as a file in the storages 2A and 2B using the LFS. The IFS is a file system that realises storage of data by appending an edit log representing edits made to a file.

A file is a set of blocks. Examples of a file include a text file and an image file. The file includes actual file details and additional management information.

The host device 1 stores data in the storages 2A and 2B using the data migration. The data migration is also called tiering. The data migration is a technique of combining plural devices (such as an SSD, an HDD, or an archive) having different characteristics to constitute a storage system. In other words, the data migration is a technique of appropriately disposing data in any one of layers including plural storage devices depending on criticality or the like of data.

Data migration granularity in the a migration is a block, a chunk, a file object, a volume, or the like. The time to perform data migration is inline (writing), offline, upon archive, or the like. Data migration is determined based on a rule or based on a policy. The host device 1 determines in what “tier” to store data depending on file attributes or usages of data which is stored in the storages 2A and 2B.

The host device 1 according to this embodiment reduces the read load on the system by performing data migration only on data that is determined to be live during garbage collection (GC). The host device 1 enables describing of a policy or rule of data migration depending on the file attributes or usages (such as access history) on the basis of metadata used in the live determination.

A configuration of a file will be described below. A file is expressed by an inode which is the management information of the file. The inode includes file attributes and metadata. Information specific to the file is stored in the file attribute. Specifically, information such as file name, file size, or time stamps (date and time at which the file is created or updated) is stored in the file attributes. Information indicating owner of the file and information indicating type of the file (such as text and video) may be stored in the file attributes.

Location information of each block of the file in the storages 2A and 2B or the like is stored in the metadata. Specifically, a list of pointers to blocks (block pointers) is stored in the metadata. Data indicated by the block pointers are data parts of the file.

The configuration of a block pointer according to the first embodiment or a second embodiment to be described later is classified into a first pointer configuration example and a second pointer configuration example to be described below. The first pointer configuration example is a configuration of a block pointer when de-duplication is not performed. The second pointer configuration example is a configuration of a block pointer when de-duplication is performed. The de-duplication is a process of representing plural pieces of data having the same details, which exist in the storages 2A and 2B or a storage 2C to be described later, using one piece of data and storing the other pieces of data as a reference to the representative data. It is possible to decrease usages of the storages 2A to 2C by the de-duplication.

When a block pointer has the first pointer configuration example, the block pointer refers to a data block. When a block pointer has the second pointer configuration example, the block pointer refers to a data block via a de-duplication hash table.

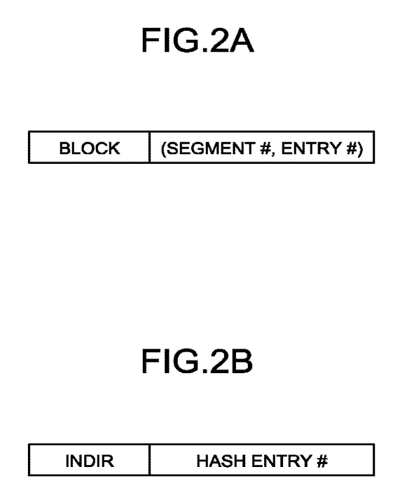

FIG. 2A is a diagram illustrating a configuration of a block pointer which refers to a data block. When a block pointer refers to a data block (in the first pointer configuration example), the block pointer includes a type identifier called “BLOCK”, a segment number (segment #) of the segment in which data (details of an edit log) is stored, and an entry location (entry #) within the segment.

FIG. 23 is a diagram illustrating a configuration of a block pointer which refers to a data block via a de-duplication hash table. When a block pointer refers to a data block via the de-duplication hash table (in the second pointer configuration example), the block pointer includes a type identifier called “INDIR” and an index into the hash map (hash entry #).

In this way, a block pointer in this embodiment has “BLOCK” indicating direct reference to a block or “INDIR” indicating indirect reference to a block as an identifier and the types of the block pointer are used properly depending on whether the de-duplication is performed. The de-duplication will be described later in detail in a second embodiment.

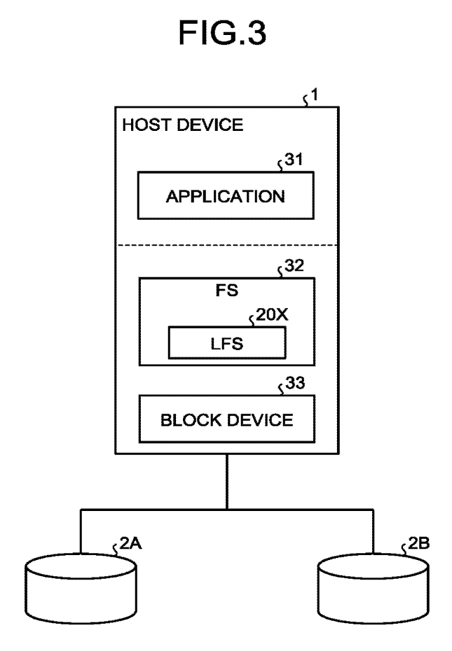

FIG. 3 is a diagram illustrating a functional configuration of the host device according to the first embodiment. The host device 1 includes an application 31 as a user program which is executed by the CPU 11, a file system (FS) 32, and a block device 33.

The application 31 includes a control program for controlling, for example, the LFS, the data migration, and the data management. The application 31 includes a control program for controlling reading, writing, and erasing of data with respect to the storages 2A and 2B.

The FS 32 a system for realizing a data managing function of the OS. The FS 32 manages data as a file.

The FS 32 includes an LFS 20X. The LFS 20X stores data by appending an edit log of a file to a segment In the LFS 20X, an edit log is not overwritten during a data update process but is stored in a different area in the storages 2A and 2B. The block device 33 provides data reading/writing function of the OS. The block device 33 performs reading/writing of data on the storages 2A and 2B in block units (for example, a 4 KB block).

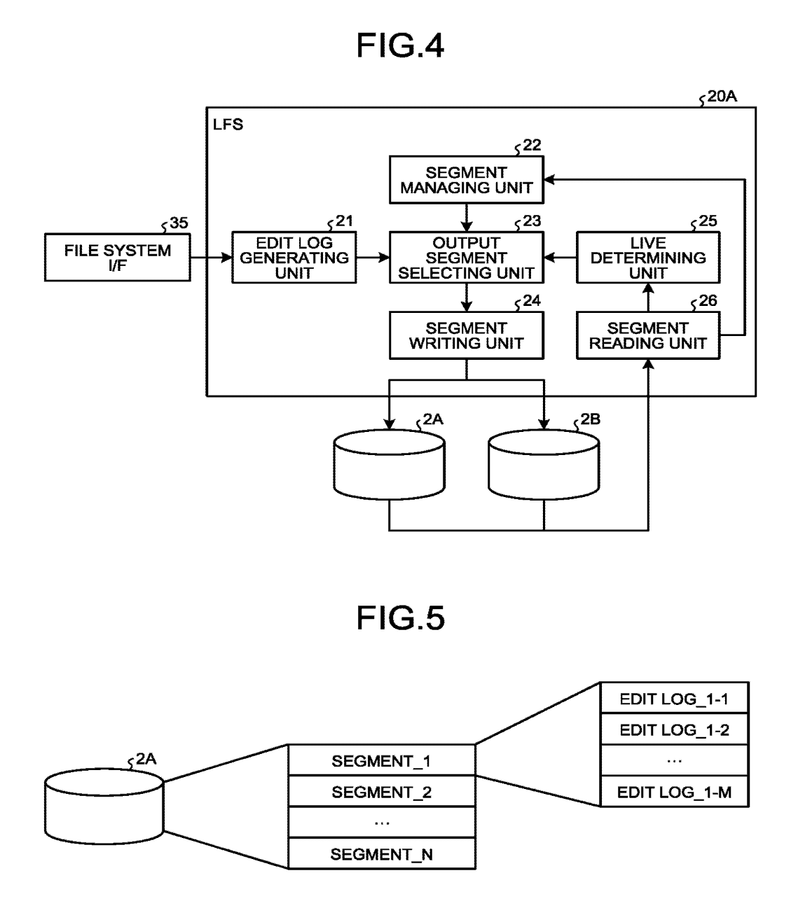

FIG. 4 is a block diagram illustrating a configuration of the LFS according to the first embodiment. The LFS 20A is an example of the LFS 20X. The LFS 20A is connected to a file system I/F 35. The file system I/F 35 is a communication interface between the LFS 20A and an element external to the LFS 20A.

The LFS 20A includes an edit log generating unit 21, a segment managing unit 22, an output segment selecting unit 23, a segment writing unit 24, a live determining unit 25, and a segment reading unit 26.

The edit log generating unit 21 is connected to file system I/F 35. Information indicating a user's operation to a file is input to the edit log generating unit 21 via the file system I/F 35. The edit log generating unit 21 generates an edit log representing the file operation by the user. The edit log includes information indicating at what position (offset) of what file data editing is performed. The edit log generating unit 21 sends the generated edit log to the output segment selecting unit 23.

The segment managing unit 22 is connected to a segment management table 42 to be described later. The segment managing unit 22 manages the storages 2A and 2B for each segment on the basis of the segment management table 42. The segment management table 42 is a table holding information on the usages of segments in the storages 2A and 2B. The segment managing unit 22 allocates a new segment on the basis of the segment management table 42 and sends the allocated segment to the output segment selecting unit 23.

FIG. 5 is a diagram illustrating a configuration of a storage. Since the storages 2A and 2B have the same configuration,the configuration of the storage 2A will be described herein.

The storage 2A is divided into segments of fixed length (for example, 2 MBytes). A segment is a certain unit of processing (for example, a unit of erasing data). In FIG. 5, a case in which the storage 2A is divided into SEGMENT 1 to SEGMENT N (where N is a natural number) is illustrated.

Each of SEGMENT_1 to SEGMENT_N is divided into a header part and a data part. A list of entries is stored in the header part. There are three types of entries. Specifically, the entries are classified into three types of an entry with a “BLOCK” identifier, an entry with an “ORIGIN” identifier, and an entry with an “INDIR” identifier. In this embodiment, the entry with a “BLOCK” identifier is used.

The entry with a “BLOCK” identifier is an entry for a data block which is referred from a file, and information to lookup the inode map 41 (file #, offset, version) and the location in the data part (data location) are stored therein. An edit log is stored at the location in the data part.

The data part of each of SEGMENT_1 to SEGMENT_N is configured to store plural edit logs. Specifically, SEGMENT_1 is configured to store edit log_1-1 to edit log_1-M (where M is a natural number). Similarly, SEGMENT_2 is configured to store edit log_2-1 to edit log_2-M and SEGMENT_N is configured to store edit log_N-1 to edit log_N-M.

In the following description, any one of SEGMENT_1 to SEGMENT_N may be referred to as SEGMENT_x. Accordingly, x is a natural number of 1 to N. Any one of edit log_x-1 to edit log_x-M may be referred to as edit log_x-y. Accordingly, y is a natural number of 1 to M. Edit log_x-y indicates what data editing is performed on what offset of what file (file #, offset).

A sequence of storing edit log_x-y (y=1 to M) in SEGMENT_x (x=1 to N) will be described below. SEGMENT_x constitutes the first to M-th areas and edit log_x-1 to edit log_x-M are appended in the order of the first to M-th areas. Accordingly, edit log_x-y is stored in the y-th area of SEGMENT_x.

When the first edit log_1-1 is generated, the LFS 20A stores edit log_1-1 in the head (the first area) of SEGMENT_1. When second edit log_1-2 is generated, the LFS 20A stores edit log_1-2 in the second area subsequent to the first area in SEGMENT_1. In this way, the LFS 20A sequentially writes edit log_1-y to SEGMENT_1. When edit log_1-1 to edit log_l-M are stored in SEGMENT_1 and SEGMENT_1 becomes full, the LFS 20A sequentially stores edit log_2-1 to edit log_2-M in SEGMENT_2 next to SEGMENT_1.

SEGMENT_1 to SEGMENT_N are cleaned by the GC at a certain time. Accordingly, a segment in which edit log_s can be stored is made available. In the GC, it is determined whether each edit log_x-y in the segment is live. In the GC, only live edit log_x-y is copied to a new segment and the original segment is released (reused). The number of edit log_s x-y which are stored in SEGMENT_1 to SEGMENT_N does not need to be a fixed value. Accordingly, edit log_s x-y corresponding to the size of the edit log_x-y are stored in SEGMENT_1 to SEGMENT_. M.

The segment management table 42 is a table indicating usages of each SEGMENT_x. The segment management table 42 indicates up to what storage location edit log_x-y is stored for each SEGMENT_x. Specifically, in the segment management table 42, SEGMENT_x is correlated with information (utilization) indicating up to what storage location edit log_x-y is stored.

The segment managing unit 22 updates the segment management table 42 when edit log_x-y is stored in SEGMENT_x. Specifically, the segment managing unit 22 updates the segment management table 42 when a user operates on a file or when the GC is performed. When a user operates on a file or when the GC is performed, the segment managing unit 22 sends the segment management table 42 to the output segment selecting unit 23. The segment managing unit 22 may acquire the location at which edit log_x-y can be stored from the segment management table 42 and send the location to the output segment selecting unit 23.

The output segment selecting unit 23 accumulates edit log_x-y in a certain memory when edit log_x-y is sent from the edit log_generating unit 21. The output segment selecting unit 23 sends the accumulated edit log_x-y to the segment writing unit 24 when the total size of the accumulated edit logs_x-y reaches the segment size. In this embodiment, the output segment selecting unit 23 prepares segments for the storage 2A and the storage 2B. The output segment selecting unit 23 selects one of the segments for the storage 2A or the segments for the storage 23 to store edit log_x-y.

The output segment selecting unit 23 may select a storage using any method. The selecting of the storage by the output segment selecting unit 23 depends on priority of storage location candidates.

The output segment selecting unit 23 sends storage designation information indicating which of the storages 2A and 2B is selected to the segment writing unit 24. The output segment selecting unit 23 sends the accumulated edit logs_x-y and the storage designation information to the segment writing unit 24 in correlation with each other.

In the GC, the output segment selecting unit 23 selects the migration destination for edit log_x-y from the storages 2A or 2B. The output segment selecting unit 23 selects the storage as the migration destination of edit log_x-y on the basis of t least one of the file attribute and the metadata.

The file attribute includes information of a file corresponding to an edit log_or usage of the file. Accordingly, the output segment selecting unit 23 determines in which “tier” the edit log should be stored on the basis of information (management information) of the file attribute corresponding to edit log_x-y or the usage of the file. Accordingly, when the GC is performed, the output segment selecting unit 23 selects one storage based on the management information such as the file attribute corresponding to edit log_x-y or the usage.

The output segment selecting unit 23 selects one storage, for example, using a function of file attributes. The output segment selecting unit 23 may select the storage 2A which is faster than the storage 2B, for edit log_x-y of a file with usage frequency higher than a certain value. On the other hand, the output segment selecting unit 23 may select the storage 2B which is slower than the storage 2A, for edit log_x-y of a file with usage frequency equal to or lower than a certain value.

The output segment selecting unit 23 sends the storage designation information indicating which of the storages 2A and 2B is selected to the segment writing unit. 24. The output segment selecting unit 23 sends edit log_x-y which is stored in the selected storage and the storage designation information to the segment writing unit 24.

When edit log_x-y is received from the output segment selecting unit 23, the segment writing unit 24 appends edit log_x-y to a segment for the storage designated by the storage designation information. When the storage 2A is designated by the storage designation information, the segment writing unit 24 appends edit log_x-y to the segment for the storage 2A. When the storage 2B is designated by the storage designation information, the segment writing unit 24 appends edit log_x-y to the segment for the storage 2B.

The segment in which edit log_x-y is accumulated by the segment writing unit 24 functions as an output buffer. In this embodiment, the segment in which edit log_x-y is accumulated by the segment writing unit 24 is prepared for each of the storages 2A and 2B.

When the segment becomes full with edit logs_x-y, the segment writing unit 24 writes edit log_x-y as a whole segment to the storage designated by the storage designation information. In other words, when a segment is fully constructed, the segment writing unit 24 writes the segment to the storage designated by the storage designation information.

The segment reading unit 26 selects and reads SEGMENT_x to be subjected to the GC from the storages 2A and 2B. The segment reading unit 26 sends each edit log_x-y in the SEGMENT_x read to the live determining unit 25. The segment reading unit 26 notifies the SEGMENT_x read as free SEGMENT_x to the segment managing unit 22.

The live determining unit 25 is connected to an inode map 41. The inode map 41 is stored in the storages 2A and 2B. The live determining unit 25 determines whether edit log_x-y subjected to the GC is live using the inode map 41. The inode map 41 is a table mapping a file to an inode (management information of the file). Storage location information of edit log_x-y includes an offset into the file. The live determining unit 25 according to this embodiment acquires an inode from the inode map 41 and acquires a file attribute and metadata of the file from the inode. The live determining unit 25 performs the live determination on the basis of edit log_x-y or information in the inode the file attribute and the metadata of the file).

A determination criterion on whether edit log_x-y is live is whether edit log_x-y can be reached from the inode map 41. The live determining unit 25 extracts the storage location information corresponding to edit log_x-y subjected to the GC front the inode map 41. When the extracted storage location information refers to edit log_x-y, the live determining unit 25 determines that edit log_x-y is live. On the other hand, when the extracted storage location information does not refer to edit log_x-y, the live determining unit 25 determines that edit log_x-y is not live. The latter happens when the host device 1 updates the inode map 41 when a file operation is performed by a user, when the GC is performed, or the like.

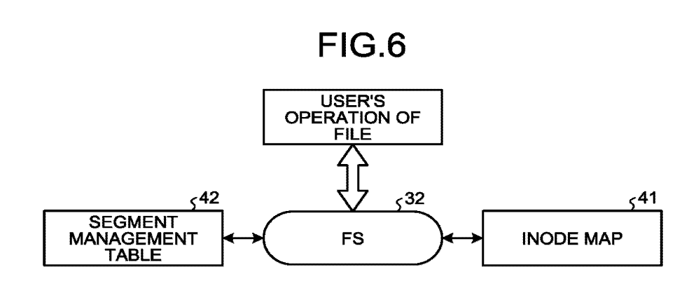

FIG. 6 is a diagram illustrating relationships between the FS and various tables. The FS 32 operates in response to a user's file operation. The FS 32 is connected to the segment management table 42 and the inode map 41. The segment management table 42 is also called a segment summary, a segment usage table, or the like. The inode map 41 is also called a file map, a file table, or the like.

The segment management table 42 is a list of all segments. The segment management table 42 is stored in the storages 2A and 2B. Information identifying the in-use state of a segment and the amount of data which is live in the segment are stored in the segment management table 42. The in-use state and the data amount information are used by the GC. The segment management table 42 is updated by the FS 32, for example, when a segment operation is performed such as when a new segment is allocated or when a segment is reclaimed by the GC.

The output segment selecting unit 23 and the segment writing unit 24 store edit log_x-y based on the user's file operation in the storages 2A and 2B for each segment using the segment management table 42. The output segment selecting unit 23 and the segment writing unit 24 store edit log_x-y in the storages 2A and 2B for each segment using the segment management table 42 at the time of the GC.

The inode map 41 is a list of all files in the storages 2A and 2B. The inode map 41 is stored in the storages 2A and 2B. Each inode includes file attributes and metadata. The file attributes include information such as update time of the file and size of the file. The metadata includes information indicating locations of file data in the storages 2A and 2B.

An unique integral number is assigned to each file. This number is called the inode number of the file or file number. File numbers may be referred to as “file #” for short. The inode map 41 is a table which maps file numbers to the location of the inode with in storage. The location is represented as a block pointer described below. The block pointer to inode data is called the inode pointer.

When a file is updated, it is necessary to change its file attribute or the metadata. In this embodiment, since a file is managed using the LFS 20A, data which has been written to the storages 2A and 2B is not overwritten and is additionally written to another area (segment). Accordingly, when a file is updated, the segment managing unit 22 creates a new inode corresponding to edit log_x-y and appends the created inode to the segment. The segment managing unit 22 writes the location of the append (a new location of edit log_x-y) to the inode map 41. Specifically, the segment managing unit 22 rewrites the inode map 41 with a new location of edit log_x-y.

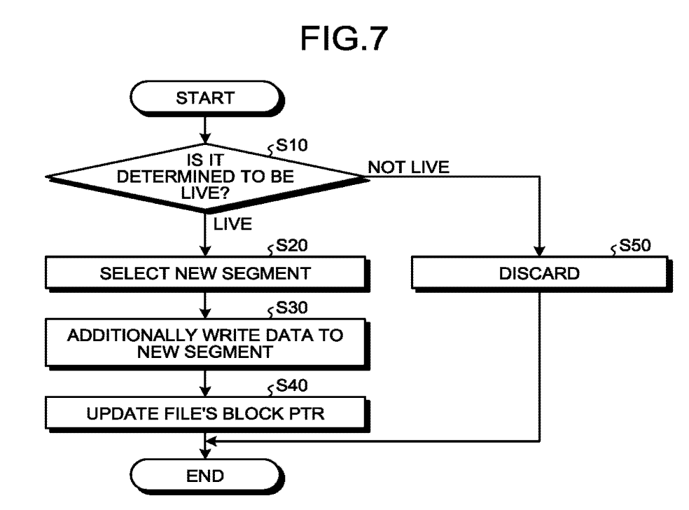

FIG. 7 is a flowchart illustrating a process flow of a data migration process according to the first embodiment. The host device 1 according to this embodiment performs data migration at the time of the GC. In the GC, the segment reading unit 26 selects and reads SEGMENT_x to be subjected to the GC from the storages 2A and 2B.

The live determining unit 25 performs live determination of determining whether edit log_subjected to the GC is live on the basis of the inode map 41 (Step S10). The live determination will be described below.

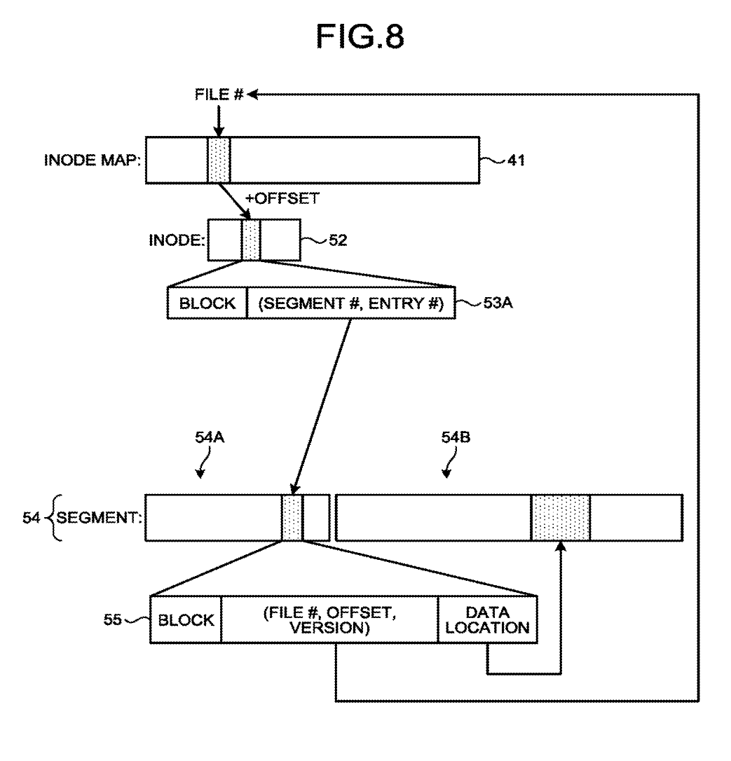

FIG. 8 is a diagram illustrating a live determining process according to the first embodiment. FIG. 8 illustrates a relationship between a file and data. Plural file numbers (file #) are registered in the inode map 41. Each file # is correlated with information indicating a location of the inode 52 which is management information of the file.

The inode 52 stores a list of block pointers and is indexed by the file offset. Accordingly, in the LFS 20A, a block pointer 53A in the inode 52 is acquired by designating file # and an offset.

The block pointer 53A includes information indicating a “BLOCK” identifier, a segment (segment #) in which data is stored, and an entry location (entry #) in the segment. By specifying the block pointer 53A, a segment 54 indicated by segment # and the entry location in the segment 54 are specified.

The segment 54 includes a header part 54A and a data part 54B. A block entry 55 for an edit log is stored in the header part 54A. Information to lookup the inode map 41 (reverse pointer) and location in the data part 54B (data location) are stored in the block entry 55. In the information to lookup the inode map 41, a “BLOCK” identifier, a file #, an offset, and a version, and the like are stored. Details of the edit are stored at the location in the data part 54B designated by the data location. Information including the block entry 55 and the edited details is the edit log_x-y.

When data is referred to by a file, the following processes of (s1) to (s5) are performed.

(s1) By specifying a file # in the inode map 41, an inode 52 is determined on the basis of the file #.

(s2) By specifying an offset in the inode 52, an block pointer 53A at the offset in the inode 52 is referred. The block pointer 53A should have the “BLOCK” identifier.

(s3) A segment 54 and a segment entry (the block entry 55) indicated by the block pointer 53A are determined.

(s4) A data location stored in the block entry 55 of the segment 54 is determined.

(s5) Data stored at the location of data location is the desired data.

On the other hand, when a file is to be determined from data, the following processes of (s6) and (s7) are performed.

(s6) A reverse pointer stored in the block entry 55 in the segment 54 is referred to.

(s7) The inode map 41 is referred to on the basis of the reverse pointer (file #, offset).

In this configuration, the live determining unit 25 performs live determination on edit log_x-y using the inode map 41. Specifically, the live determining unit 25 determines that the entry is a live entry when the block pointer 53A in the inode 52 traced via the reverse pointer through inode map 41 points back to the entry. On the other hand, when the block pointer 53A in the inode 52 refers to another entry, it means that the file is updated after the segment 54 is created. Accordingly, an entry which does not point back to the block entry 55 itself is a dead entry (reclaimed as garbage).

For example, the live determining unit 25 reads a block entry 55 from the segment (the segment subjected to the GC) read by the segment reading unit 26. The block entry 55 includes a file # and an offset which are information for traversing the inode map 41. The live determining unit 25 searches the inode map 41 for the file # of the file corresponding to edit log_x-y of the block entry 55. Accordingly, the live determining unit 25 specifies the inode corresponding to the file #. The live determining unit 25 reads the block pointer 53A from the inode 52 on the basis of the offset.

The live determining unit 25 determines whether the location of the block entry 55 read from the segment subjected to the GC and the block pointer 53A from the inode 52 are the same. When the block entry 55 subjected to the GC and the block pointer 53A from the inode 52 are the same, the live determining unit 25 determines that edit log_x-y subjected to the GC is live. When the block entry 55 subjected to the GC and the block pointer 53A from the inode 52 are different, the live determining unit 25 determines that the block entry (edit log_x-y) subjected to the GC is not live.

When edit log_x-y subjected to the GC is live (live in Step S10), the output segment selecting unit 23 selects a new segment (Step S20). At this time, the output segment selecting unit 23 selects a storage (a copy destination device) as a migration destination of edit log_x-y from the storages 2A and 2B on the basis of the file attribute or the metadata of the file of edit log_x-y. In other words, the output segment selecting unit 23 relents a new segment in which edit log_x-y is stored from the storages 2A and 2B on the basis of the file attribute or the metadata corresponding to edit log_x-y. The metadata used by the output segment selecting unit 23 is the same as the metadata used in the live determination. The output segment selecting unit 23 may select a storage from the storages 2A and 2B as a migration destination of edit log_x-y based on the information contained in edit log_x-y.

The output segment selecting unit 23 selects from the storages 2A and 2B the migration destination of edit log_x-y, for example, on a block by block basis. For example, the output segment selecting unit 23 selects a specific device (the storage 2A or the storage 2B in this embodiment) for a block in which management information of the system (the FS 32) is made persistent. The output segment selecting unit 23 selects a specific device for a block storing the file attribute or the inode (the block list). The output segment selecting unit 23 selects a specific device for a block (or a file) storing a directory of files. Here, a directory is management information of files and constitutes a mapping from file names to file entities.

The output segment selecting unit 23 may define for each file a group of blocks being simultaneously accessed. In this case, the output segment selecting unit. 23 groups blocks constituting a file and select storage for the group. For example, the output segment selecting unit 23 may group blocks specified by offsets in the file. The output segment selecting unit 23 selects a storage for each such group. The output segment selecting unit 23 may group, for example, file attributes (inodes) and certain blocks (certain logs). The certain blocks are P blocks (where P is a natural number) from the head, Q blocks (where Q is a natural number) from the tail, and blocks designated using other designation methods (for example, blocks of elements). When certain blocks are grouped, the output segment selecting unit 23 selects a storage as a storage destination of the grouped blocks on the basis of a function indicated by an offset in a file. For example, the output segment selecting unit 23 may group blocks of a file in advance on the basis of an access frequency.

The segment writing unit 24 appends edit log_x-y to the new segment for a storage (Step S30). The segment managing unit 22 updates a file's block pointer (Step S40). Specifically, the segment managing unit 22 updates the inode map 41, the inode 52, the segment 54, and the like.

The segment managing unit 22 may store additional information as metadata in the inode 52 when updating the inode 52. An example of the additional information is the number of times edit log_x-y survives through the GC (the number of times in which the edit log is not reclaimed by the GC). In other words, the additional information is the number of times in which edit log_x-y has been processed the GC. The segment managing unit 22 may store information used in the GC or the data migration as a file attribute when updating the inode 52. Accordingly, the LFS 20A can perform future data migration using the metadata or the file attribute stored in the inode 52. An element other than the segment managing unit 22 in the FS 32 may update the file's block pointer. The segment managing unit 22 may store the number of times in which edit log_x-y has been processed by the GC in the file attribute or the edit log_x-y. In this case, the LFS 20A selects a storage as a migration destination of edit log_x-y from the storages 2A and 2B on the basis of the number of times in which the edit log has been processed by the GC when the GC is performed in the future.

When it is determined in the live determination that edit log_x-y subjected to the GC is not live (not live in Step S10), the live determining unit 25 discards edit log_x-y determined not to be live (Step S50).

When the storages 2A and 2B are solid state drives (SSDs), the hostdevice 1 uses the erase block of a NAND type flash memory used in the SSD in place of a segment. When the storages 2A and 2B are SSDs, the host device 1 uses the read or write page of a NAND type flash memory included in the SSD in place of a block.

According to the first embodiment, since the host device 1 performs the data migration only on data which is determined to be live in the live determination of the GC, it is possible to reduce data read or write load. Redundant load for migrating a dead block (data determined not to be live) is not generated. Selection of a migration destination depending on an individual file or block state can be described as a policy or a rule.

The host device 1 performs the data migration (selection of the storage 2A or 2B) depending on the file attribute or the access history on the basis of the metadata used in the live determination. Accordingly, the host device 1 can easily perform data migration while suppressing read or write load.

### Second Embodiment

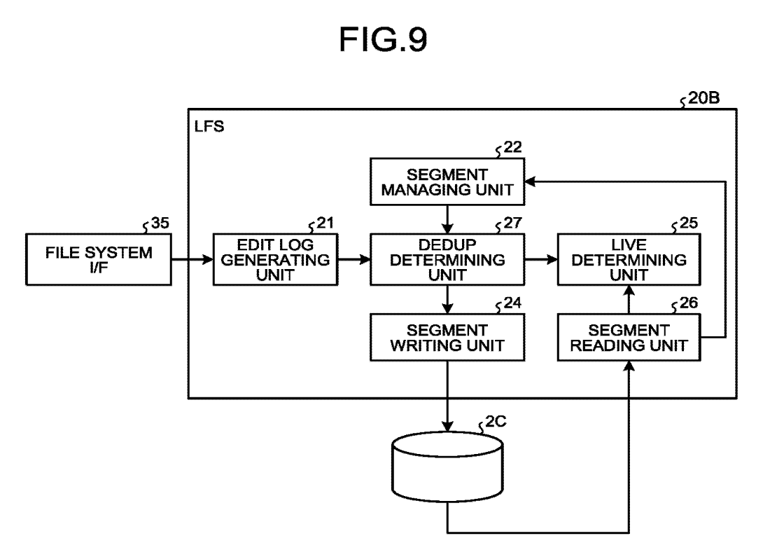

A second embodiment will be described below with reference to FIGS. 9 to 13. In the second embodiment, the LFS 20X performs de-duplication. The LFS 20X performs live determination of data, for example, on the basis of the file attribute when performing the GC. The LFS 20K performs duplication determination on data which is determined to be live in the live determination and performs copying of data or generating of a reference link as a result thereof.

FIG. 9 is a block diagram illustrating a configuration of an LFS according to the second embodiment. The LFS 20B is an example of the LFS 20X. The elements of LFS 20B illustrated in FIG. 9 performing the same functions as the LFS 20A in the first embodiment illustrated in FIG. 4 will be referenced by the same reference signs and description thereof will not be repeated. The LFS 20B is connected to a storage 2C and a file system I/F 35.

The LFS 20B includes an edit log generating unit 21, a segment managing unit 22, a DEDUP determining unit 27, a segment writing unit 24, a live determining unit 25, and a segment reading unit 26.

The DEDUP determining unit 27 controls performing of de-duplication using at least one of a file attribute and metadata. Specifically, the DEDUP determining unit 27 performs suppressing of a de-duplication process, selecting of a block to be de-duplicated, and the like using at least one of a file attribute and metadata.

When edit log_x-y is sent from the edit log generating unit 21, the DEDUP determining unit 27 sends edit log_x-y to the segment writing unit 24. The DEDUP determining unit 27 determines whether to de-duplicate data to be written to the storage 2C for each block. The DEDUP determining unit 27 may determine whether to de-duplicate data in units of a file, a fixed-length block, or a variable-length block. For example, the DEDUP determining unit 27 determines whether to de-duplicate data (edit log_x-y) which was determined to be live in the live determination of the GC.

The DEDUP determining unit 27 determines whether to perform the de-duplication in two steps. Specifically, first, the DEDUP determining unit 27 determines whether de-duplication should be performed or not. When the data is to be de-duplicated, the DEDUP determining unit 27 determines whether duplicated data exists in the storage 20. When duplicated data exists in the storage 20, the DEDUP determining unit 27 appends a reference as an INDIR entry 67 to be described later. In other words, when plural files refer to data with the same ORIGIN, the DEDUP determining unit 27 appends an INDIR entry 67 to note there is a reference.

When duplicated data does not exist in the storage 2C, the DEDUP determining unit 27 determines whether to register data as candidate for duplicate data. When the DEDUP determining unit 27 determines that the data is registered as duplicate candidate, the data is registered as duplicate candidate in the storage 2C. When the DEDUP determining unit 27 determines that the data does not require de-duplication, the data is written as normal data in the storage 2C.

The segment writing unit 24 writes data to the storage 2C in units of segments. The segment reading unit 26 selects and reads SEGMENT_x to be subjected to the GC from the storage 2C. The segment reading unit 26 sends the SEGMENT_x read to the live determining unit 25. Similar to the first embodiment, the live determining unit 25 determines whether edit log_x-y subjected to the GC is live. In this embodiment, the live determining unit 25 may perform the live determination on the basis of edit log_x-y or information in an inode (a file attribute and metadata of the file).

Two blocks are determined as duplicate when their hash value are identical. A block's hash value is calculated by passing the block's data through a one-way hash function such as MD-5 or SHA-1 hash function. A hash map is provided to map a hash value to information used for registering and detecting a duplicated block. The information used includes information identifying the segment (segment #), location within the segment (entry #), and the number of block pointers referring to the block. Hereinafter, the hash function is assumed to have no collisions and the hash map is represented as an array indexed by the hash values, for simplicity, but is not a requirement for this embodiment.

Segment entries according to the second embodiment will be described below. The configurations of the segment entries according to the second embodiment are classified into one of the first to third entry configuration examples to be described below. The first entry configuration example is an entry with an “ORIGIN” identifier, and the second entry configuration example is an entry with an “INDIR” identifier. The third entry configuration example is an entry with a “BLOCK” identifier and is the same configuration as the block entry 55 described in the first embodiment. Accordingly, description thereof will not be repeated.

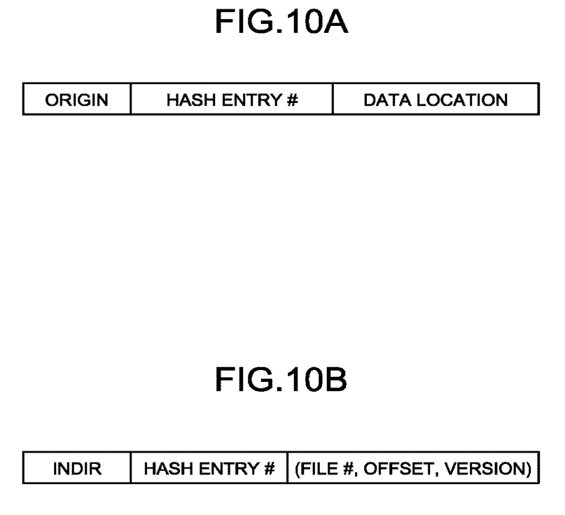

The entry with the “ORIGIN” identifier is for blocks selected by de-duplication as a representative block (an origin block). FIG. 10A is a diagram illustrating an entry configuration of a segment when an entry is selected by de-duplication as a representative block. An index of a hash map (hash entry #) and a location in a data part (data location) are stored in an entry with the “ORIGIN” identifier.

The entry with the “INDIR” identifier indicates that a file refers to a representative block after de-duplication is performed. FIG. 10B is a diagram illustrating an entry configuration of a segment when a file refers to a representative block after de-duplication is performed. An index of a hash map and information to lookup the inode map 41 (a file #, an offset, and a version) are stored in an entry with the “INDIR” identifier.

When data of a file is referred to, tracing the hash map yields an entry with the “ORIGIN” identifier. There is no method to trace back to a file from the entry with the “ORIGIN” identifier, and entries with the “ORIGIN” identifier must trace back to multiple files. Accordingly, by appending an entry with the “INDIR” identifier for each file referring to an entry with the “ORIGIN” identifier, reverse pointers from the entry with the “ORIGIN” identifier to multiple files is expressed. The entry with the “BLOCK” identifier described in the first embodiment is used as an entry of a segment not subjected to de-duplication.

The de-duplication process according to the second embodiment will be described below. The host device 1 performs a first de-duplication process for a segment entry with the “BLOCK” identifier (a normal block), a second de-duplication process for a segment entry with the “ORIGIN” identifier (an original block), and a third de-duplication process for a segment entry with the “INDIR” identifier (an indirect reference). First, the de-duplication process for a block of the “BLOCK” identifier will be described (the first de-duplication process).

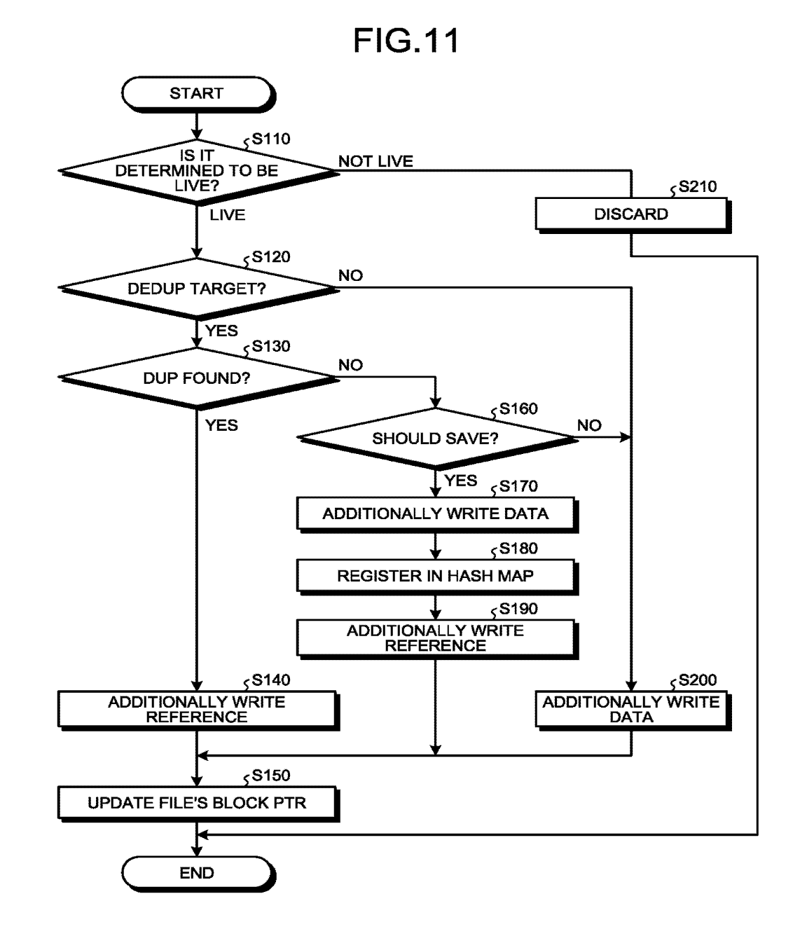

FIG. 11 is a flowchart illustrating a process flow of the first de-duplication process according to the second embodiment. The host device 1 according to this embodiment performs the de-duplication on a segment entry of the “BLOCK” identifier in the GC. In the GC, the segment reading unit 26 selects and reads SEGMENT_x to be subjected to the GC from the storage 20.

The live determining unit 25 performs the live determination of determining whether edit log_x-y subjected to the GC is live or not on the basis of the inode map 41 and the metadata (Step S110). When edit log_x-y subjected to the GO is live (live in Step S110), the DEDUP determining unit 27 determines whether edit log_x-y is data to be de-duplicated (Step S120).

The DEDUP determining unit 27 may determine whether data is to be de-duplicated on the basis of an attribute associated with a block. In this case, the number of times in which edit log_x-y has been processed by the GC is stored in the attribute of the block. When the edit log_is was not reclaimed in the GC exceeds a threshold number of times, the DEDUP determining unit 27 determines that the edit log_is appropriate for archive and is to be de-duplicated. The segment managing unit 22 may store the number of times in which edit log_x-y was processed by the GC in the file attribute or the edit log_x-y. In this case, the LFS 20B, when performing the GC later, determines whether the edit log_is to be de-duplicated on the basis of the number of times in which the edit log_has been processed by the GC.

When the edit log_is to be de-duplicated (Yes in Step S120), the DEDUP determining unit 27 determines whether duplicate data exists in the storage 25 (Step S130). When duplicate data exists in the storage 2C (Yes in Step S130) (found existing), the DEDUP determining unit 27 appends as a reference an INDIR entry 67 (a marker for de-duplication) to the segment 66 (Step S140). Then, the segment managing unit 22 updates the file's block pointer (metadata) (Step S150). Specifically, the segment managing unit 22 updates the inode map 41, the inode 52, the segment 54, and the like.

The segment managing unit 22 may store (make persistent) additional information as metadata in the inode 52 when updating the inode 52. The segment managing unit 22 may store information used for the GC or the de-duplication as a file attribute in the inode 52 when updating the inode 52. Accordingly, the LFS 20B can perform future de-duplication using the metadata or the file attribute stored in the inode 52. An entity other than the segment managing unit 22 in the FS 32 may update the file's block pointer.

When duplicate data does not exist in the storage 2C (No in Step S130), the DEDUP determining unit 27 determines whether the data should be registered as duplicate data (Step S160). The process of Step S160 is a process of determining whether to register this data when no registered data exists. This process is performed to determine whether there is high possibility that the same data will come in the future. In other words, the process of S160 determines whether data which has no duplicate in the storage 2C should be managed as a de-duplication candidate in the future.

When there is high possibility that the same data will come in the future, the DEDUP determining unit 27 determines that the data should be registered as duplicate data. On the other hand, when there is low possibility that the same data will come in the future, the DEDUP determining unit 27 determines that the data should not be registered as duplicate data.

The DEDUP determining unit 27 according to this embodiment determines whether it is necessary to perform de-duplication or not on the basis of the file attribute or the metadata which was used in the live determination. Examples of the file attribute include file size, access control, date and time at which the file is created, or user-defined attributes for each file.

The DEDUP determining unit 27 determines that, for example, data having high use frequency should be registered as duplicated data. On the other hand, the DEDUP determining unit 27 determines that, for example, data having low use frequency should be stored as normal data.

When the DEDUP determining unit 27 determines that data should be registered as duplicate data (Yes in Step S160), data (a block) is appended to the data part 54B of the segment 54 (Step S170).

The segment managing unit 22 registers information on the data in the hash map 61 (Step S180). Specifically, the segment managing unit 22 registers the hash value of the data block of the data in the hash map 61. The segment managing unit 22 registers the segment # for identifying the segment in which the data is stored and information entry # indicating the location in the segment in the hash map 61. The segment managing unit 22 registers the number of block pointers (the reference count) which refer to the data block of the data in the hash map 61.

The segment managing unit 22 appends as a reference an INDIR entry 67 to the segment 66 (Step S190). The segment managing unit 22 updates the file's block pointer (Step S150). Specifically, the segment managing unit 22 updates the inode map 41, the inode 52, the segment 54, and the like.

The DEDUP determining unit 27 determines that files other than regular files are not to be de-duplicated. For example, the DEDUP determining unit 27 determines that the system's management data that are made persistent are not to be de-duplicated. The DEDUP determining unit 27 determines that a block storing the file attribute or metadata of an inode is not to be de-duplicated. The DEDUP determining unit 27 determines that the file attributes listed in the filesystem FS32's configuration parameters are not to be de-duplicated. For example, the DEDUP determining unit 27 determines that a block storing a directory, which is management information of the storage 2C, is not to be de-duplicated.

The DEDUP determining unit 27 may store in the file attribute whether the file was determined to be de-duplicated. The file attribute including this determination result may be made persistent. An attribute indicating that a file is not to be de-duplicated may be stored in the file in advance. Setting of this attribute is determined by an algorithm.

When the edit log is not data to be de-duplicated (No in Step S120), the DEDUP determining unit 27 appends data to the data part 54B of the segment 54 (Step S200). The segment managing unit 22 updates the file's block pointer (Step S150). Specifically, the segment managing unit 22 updates the inode map 41, the inode 52, the segment 54, and the like.

When it is determined that the data to be de-duplicated should not be registered as duplicate data (No in Step S160), the DEDUP determining unit 27 appends the data block to the data part 548 of the segment 54 (Step S200). The segment managing unit 22 updates the file's block pointer (Step S150). Specifically, the segment managing unit 22 updates the inode map 41, the inode 52, the segment 54, and the like.

When it is determined in the live determination that the edit log_x-y subjected to the GC is not live (not live in Step S110), the live determining unit 25 discards the edit log_x-y determined not to be live (Step S210).

The de-duplication when the GC is not performed (during the first write to a file) is the same as the process illustrated in FIG. 11, except for the live determination. The determination of whether to be de-duplicated in this case is the same as the determination described with reference to FIG. 11. The determination of whether to be de-duplicated may be performed only at the time of write or may not be performed at the time of write.

The de-duplication process on a segment entry (an original block) with the “ORIGIN” identifier (the second de-duplication process) will be described below. A representative block (an origin block) after the de-duplication is referenced via the hash map. Since there are plural files as a reference source of the origin block, the entry of the segment does not have a reverse pointer to a file.

The live determination on the origin block is performed by the live determining unit 25 on the basis of the reference count in the hash map. The live determining process on the origin block will be described below. The LFS 20B sets the reference count to “1” when a block is newly registered in the hash map. At this time, a segment entry with the “ORIGIN” identifier is appended to the segment. Under this state, if the LFS 20B hashes another block and a match is found by searching the hash map, that is, when duplication was detected, the reference count is increased by 1. The LFS 20B appends a segment entry with the “INDIR” identifier to the segment.

When the segment entry with the “INDIR” identifier is determined not to be live at the time of performing the GC on the segment (when the segment cannot be traced from a file), the reference count of the entry of the hash map is decreased by 1.

In this way, the number of reference from a file +1 is registered in the reference count. When the block is not referred to by any file, the value of the reference count becomes “1. ” In this state, the block is referred to from only the origin block. In this state, the live determining unit 25 determines that the segment entry with the “ORIGIN” identifier is not live.

When the origin block is determined to be live, the segment writing unit 24 copies the origin block to the migration destination segment. On the other hand, when the live determining unit 25 determines that the origin block is not live, the origin block is discarded.

The de-duplication process on a segment entry with the “INDIR” identifier (an indirect reference) will be described below (the third de-duplication process). When performing the live determination on an indirect reference, the live determining unit 25 determines whether data subjected to the GC is live or not on the basis of the inode map 41 and the metadata, similar to the normal block.

When the hash entry # (hash index) of the segment entry is the same as the hash entry # acquired by tracing the file from data subjected to the GC, the live determining unit 25 determines that data subjected to the GO is live. Specifically, when a destination traced by (file #, offset) from the segment entry with the “INDIR” identifier is a block pointer with the “INDIR” identifier and the hash entry # of the block pointer matches the hash entry # of the segment entry, the live determining unit 25 determines that the data is live.

On the other hand, when the destination of (file #, offset) is not a block pointer with the “INDIR” identifier, or is a block pointer with the “INDIR” identifier with a different hash entry #, the file was updated and the entry of the segment has data before the update. Accordingly, in this case, the live determining unit 25 determines that the data is not live.

When the data subjected to the GC is live, the segment writing unit 24 copies the data subjected to the GC to the migration destination segment. In this case, the segment writing unit 24 does not copy actual data but only copies the reference. When the data subjected to the GC is not live, the live determining unit 25 discards the reference to the origin block. In this case, the segment managing unit 22 decrements the reference count of the hash map. As a result, the origin block may become not live and will discarded when the origin block is next subjected to the GC.

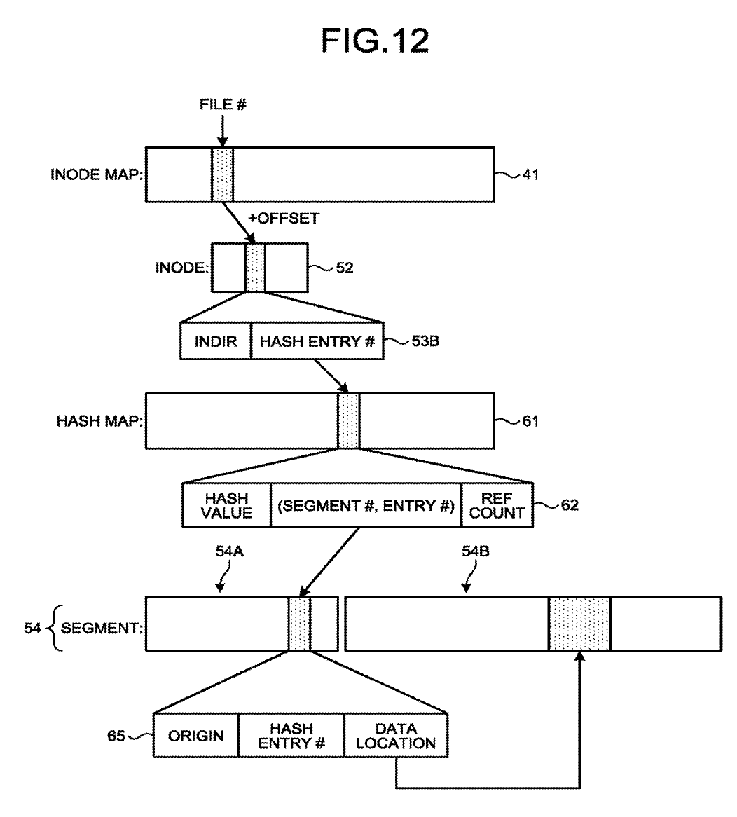

FIG. 12 is a diagram illustrating a process of referencing data from a file. FIG. 12 illustrates a relationship between a file and data. The elements illustrated in FIG. 12 that are the same as illustrated in FIG. 8 will not be repeatedly described.

Plural file numbers (file #) are registered in the inode map 41. The inode 52 stores plural block pointers. In the LFS 20B, a block pointer 53B in the inode 52 is designated by specifying a file # and an offset.

The block pointer 53B includes an “INDIR” identifier and an index into a hash map (hash entry #). The hash entry # indicates a location in the hash map 61. Hash information 62 relevant to a hash is stored at the location indicated by the hash entry #. The hash information 62 includes a hash value of a data block, information identifying a segment in which the data is stored (segment #), information indicating a location in the segment (entry #), and the number of block pointer referring to the data block (reference count).

In this way, by specifying a has entry entry #, a segment 54 indicated by a segment # and an entry location in the segment 54 are determined. The segment 54 includes a header part 54A and a data part 54B.

A block entry 65 is stored in the header part 54A. The block entry 65 include information for tracing the hash map 61 and a data storage location in the data part 54B (data location). The information for tracing the hash map 61 includes an “ORIGIN” identifier and a hash entry #. Details of the edit are stored at the location in the data part 54B designated by the data location.

When de-duplicated data is referred to from a file, the following processes of (s11) to (s15) are performed.

(s11) By specifying a file # in the inode map 41, an inode 52 is determined on the basis of the file #.

(s12) By specifying an offset in the inode 52, an block pointer 53B in the inode 52 at the offset is referred to. Here, the block pointer 53B has an “INDIR” identifier

(s13) The location in the hash map 61 indicated by the hash entry # of the block pointer 53B is referred to. Accordingly, hash information 62 designated by the hash entry # is determined. As a result, a segment 54 and a segment entry designated by the hash information 62 are determined.

(s14) A block entry 65 in the segment 54 has an “ORIGIN” identifier. Accordingly, a data location stored in the block entry 65 of the segment 54 is determined.

(s15) Data stored in the data location is the desired data.

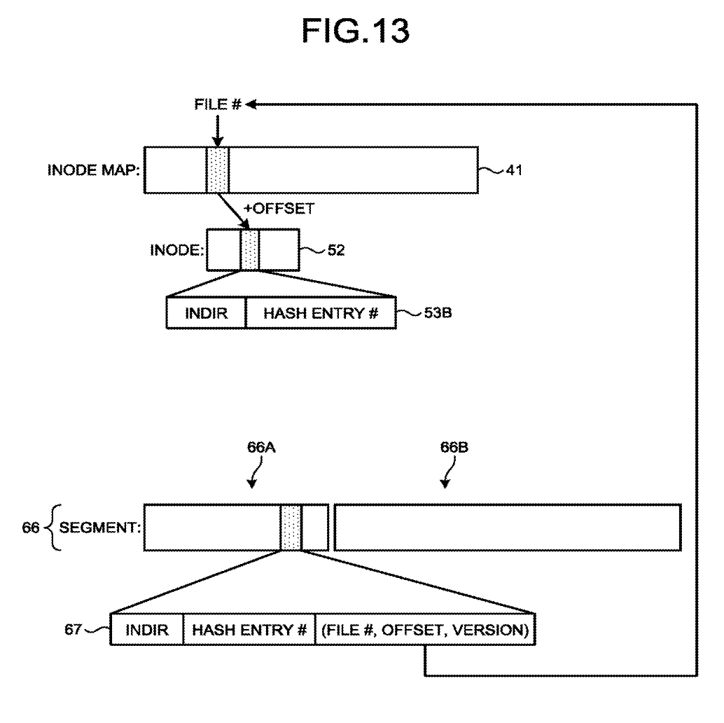

Reference to a file from data cannot be realized using only the information illustrated in FIG. 12. Accordingly, reference to a file from data is performed using information illustrated in FIG. 13. FIG. 13 is a diagram illustrating a process of referring to a file from data. FIG. 13 illustrates the relationship between a file and data. The same elements illustrated in FIG. 13 as the element illustrated in FIG. 8 or 12 will not be repeatedly described.

Plural file numbers (file #) are registered in the mode map 41. The mode 52 stores plural block pointers. In the LFS 20B, a block pointer 53B in the inode 52 is designated by specifying a file # and an offset.

A segment 66 includes a header part 66A and a data part 66B. An INDIR entry 67 is stored in the header part 66A. Information for tracing the hash map 61 and information (a reverse pointer) for tracing the inode map 41 are stored in the INDIR entry 67. The information for tracing the hash map 61 includes an “INDIR” identifier and a hash entry #. The information for tracing the inode map 41 includes a file #, an offset, a version, and the like.

When a file is referred to from data, the following processes of (s16) and (s17) are performed.

(s16) A reverse pointer stored in the entry of the “INDIR” identifier in the segment 66 is referred to.

(s17) The inode map 41 is referred to on the basis of the reverse pointer (file #, offset).

In this configuration, the live determining unit 25 performs the live determination on edit log_x-y using the inode map 41 and the metadata. Specifically, the live determining unit 25 determines that the entry is a live entry when the hash entry # stored in the block pointer 53B of a destination traced by the reverse pointer is the same as the hash entry # in the INDIR entry 67. On the other hand, when both hash entry # indicate different entries, it means that the file is updated after the segment 54 was created. Accordingly, the entry is invalid.

In this embodiment, the DEDUP determining unit 27 determines whether data is to be de-duplicated in the process of Step S120. Accordingly, it is not necessary to perform the determination process of Step S130 on data not to be de-duplicated later. As a result, it is possible to reduce a load of the determination process in Step S130.

According to the second embodiment, since the host device 1 limits de-duplication only to data determined to be live in the live determination in the GC, it is possible to reduce a data read load.

Since the host device 1 uses the metadata used in the live determination to perform de-duplication, it is possible to limit de-duplication only to data determined be live. Accordingly, since a redundant load of de-duplicating dead data is not generated, the host device 1 can improve de-duplication efficiency. Since the host device 1 limits de-duplication only to data determined to be live, it is possible to enhance access efficiency at the time of the de-duplication.

Since the host device 1 performs the de-duplication of data on the basis of file attribute or metadata, it is possible to control de-duplication performed at the block granularity using information only available at file granularity.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A host device comprising:
a processor that stores a log of a file in plurality of storages using a log-structured file system, the processor selecting in which of the plurality of storages to store a log that is determined to be live in garbage collection which is a process of determining whether the log is live.

2. The host device according to claim 1, wherein the processor determines whether a log is live or not in garbage collection on the basis of attribute information of the file or metadata of the file and selects the storage in which the log is stored on the basis of the attribute information or the metadata which is used in the determination.

3. The host device according to claim 2, wherein the attribute information or the metadata is stored in the log.

4. The host device according to claim 2, wherein the processor selects the storage in unit of a file.

5. The host device according to claim 3, wherein the processor selects a specific storage for a file in which management information of the log-structured file system is made persistent.

6. The host device according to claim 3, wherein the processor selects a specific storage for a file which stores management information for a directory of files.

7. The host device according to claim 3, wherein the processor groups blocks constituting the file and selects the storage for each group.

8. The host device according to claim 7, wherein the processor groups a certain number of blocks at the beginning of the file or a certain number of blocks from the end of the file.

9. The host device according to claim 8, wherein the processor groups the blocks of the file on the basis of access frequency and selects the storage for each group.

10. The host device according to claim 3, wherein the processor stores the number of times in which the log undergoes garbage collection in the log or an attribute area indicating attributes of the file and selects the storage on the basis of the number of times garbage collection was performed.

11. A host device comprising:
a processor that stores a log of a file in the storage using a log-structured file system, the processor determining whether to de-duplicate a log determined to be live in garbage collection which is a process of determining whether the log is live and de-duplicating the log determined to be de-duplicated.

12. The host device according to claim 11, wherein the processor determines whether a log is live or not in garbage collection on the basis of attribute information of a file or metadata of the file and determines whether to de-duplicate the log on the basis of the attribute information or the metadata which is used in the determination.

13. The host device according to claim 11, wherein the attribute information or the metadata is stored in the log.

14. The host device according to claim 11, wherein the processor determines whether to manage the log as a de-duplication candidate on the basis of the attribute information or the metadata of the file.

15. The host device according to claim 13, wherein the processor determines that a file in which management information of the log_-structured file system is made persistent is not de-duplicated.

16. The host device according to claim 13, wherein the processor determines that a file is not de-duplicated when its attribute is listed in a configuration parameter of the file system.

17. The host device according to claim 13, wherein the processor determines that a block which stores management information for a directory of files is not de-duplicated.

18. The host device according to claim 13, wherein the processor determines whether to de-duplicate the log on the basis of user-defined attributes.

19. The host device according to claim 14, wherein the processor stores the number of times in which the log undergoes the garbage collection in the log or an attribute area indicating attributes of the file and determines whether to de-duplicate the log on the basis of the number of times garbage collection was performed.
